(19) United States
(12) Patent Application Publication
(10) Pub. No.: US 2019/0042130 A1
(43) Pub. Date: Feb. 7, 2019

(54) PREFIX OPCODE METHOD FOR SLC ENTRY WITH AUTO-EXIT OPTION

(71) Applicant: Intel Corporation, Santa Clara, CA (US)

(72) Inventors: NAVEEN VITTAL PRABHU, Folsom, CA (US); ALIASGAR S. MADRASWALA, Folsom, CA (US); DONIA SEBASTIAN, Fair Oaks, CA (US); SHANKAR NATARAJAN, Folsom, CA (US)

(73) Assignee: Intel Corporation, Santa Clara, CA (US)

(21) Appl. No.: 15/845,596

(22) Filed: Dec. 18, 2017

(51) Int. Cl. G06F 3/06

(52) U.S. Cl. CPC G06F 3/0634; G06F 3/0679; G06F 3/0604

(57) ABSTRACT

A system for reconfiguring flash memory from a default access operation mode (e.g., MLC, TLC, or QLC mode) to a non-default access operation mode (e.g., SLC mode) using opcode prefixes is provided. Opcode prefix logic enables the flash memory die to enter a non-default (e.g., faster) access operation mode. The non-default access operation mode is entered by providing a prefix instruction or opcode prefix to the memory controller and/or to the flash memory die prior to memory operation commands (“opcode”) for program, read, and/or erase. The flash memory die is configured to automatically exit the non-default access operation mode after a single operation, or the flash memory die is configured to exit the non-default access operation mode upon receipt of another opcode prefix.

### TECHNICAL FIELD

The present disclosure relates to systems and methods for changing memory write modes in flash memory arrays.

### BACKGROUND

Flash memory, such as NAND and NOR, includes arrays of non-volatile memory cells that continue to increase in physical and logical density. That is, more memory cells are being packed into memory arrays, and newer flash memory cells enable memory controllers to store multiple bits of data in individual memory cells. The flash memory cells that have the capability to store multiple bits of data in each memory cell include, multi-level cell (“MLC”) for 2-bit data storage, tri-level cell (“TLC”) for 3-bit data storage, and quad-level cell (“QLC”) for 4-bit data storage.

The increased logical density of memory cells in flash memory arrays comes at the read/write speeds and shortened longevity of the memory cells, has compared to their single-level cell counterparts. The access speeds are elongated for the more complex memory cells because both reading and programming MLC, TLC, and QLC memory cells can take multiple iterations of addressing a word line and sensing a bit line, before datum is written to or read from these memory cells. As result, when combinations of non-volatile memory, quicker access times, and/or expanded random access memory needs arise in a system, it may be desirable to use the multi-level memory cells (generically referring to any of MLC, TLC, and QLC) in the simplified yet speedier single-level cell (“SLC”) mode.

Flash memory enables users to configure some of the blocks in SLC mode, in a mode that is known as on-the-fly SLC. On-the-fly SLC mode is used to configure flash memory cells as caching solution in a system. The SLC array operations (like program, read, or erase) for the SLC configured blocks are performed through a feature set of commands. Use of the SLC mode feature set of commands cost ˜3 μs in overhead. These are high overhead costs for modes that are being used specifically for time-savings benefits. These overhead costs are also a significant contribution to overhead when perform SLC random read operations (e.g., to read entire blocks or pages of memory cells). The overhead costs are in part due to the information transmission requirements needed to configure, read, write, and/or erase the flash memory cells in SLC mode.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic depicting an illustrative system that executes prefixes to memory access opcodes, to increase the speed (decrease the overhead) of single-level cell (“SLC”) access operations on memory cells in a memory array, according to one embodiment;

FIGS. 2A and 2B are illustrative simplified diagrams of operations for entering and exiting non-default access operation modes in flash memory, according to one embodiment; and

FIG. 3 is a high-level logic flow diagram of an illustrative method for reconfiguring flash memory from a default access operation mode to a non-default access operation mode using opcode prefixes, according to one embodiment.

Although the following Detailed Description will proceed with reference being made to illustrative embodiments, many alternatives, modifications and variations thereof will be apparent to those skilled in the art.

### DETAILED DESCRIPTION

The system and method disclosed herein reduces mode configuration overhead (e.g., even as much as 10%) for memory cells in a flash memory array. Traditionally, to operate a flash memory as a temporary storage (e.g., as cache), a memory controller receives a series of instructions that reconfigures a portion of the memory array from operating in its default mode (e.g., tri-level cell (“TLC”) mode) to a faster non-default operating mode (e.g., single-level cell (“SLC”) mode. An example of the traditional mode configuration process includes 1) send a command that indicates that an operation mode is to be changed, 2) send an address/information indicating which mode to change, 3) wait for the command and address to load, 4) transmit additional parameters of relevance for the command, and 5) wait for those commands to load. After all of this, the traditional mode configuration process leaves the die or the configured portion of the array stuck in this non-default mode until a similar mode configuration process is performed to put the die or portion of the array back into default operating mode. This overhead does not completely eliminate the value of the faster operating mode (e.g., SLC mode), but the overhead does strongly negate the primary benefit of faster access speeds.

To further explain the problem being addressed and/or resolved by the present disclosure, it should be noted that typically an entire flash memory die of an array of flash memory dice is being reconfigured during the operating mode reconfigurations. In other words, if one of only two or three flash memory dice is stuck in SLC mode then load balancing and wear algorithms can be affected until the SLC configured flash memory die is reconfigured into its default (e.g., TLC) mode.

The embodiments of the present disclosure alter the operation of memory controllers and/or the operation of flash memory die by enabling the flash memory die to enter a faster access operation mode (e.g., SLC mode) with a prefix instruction or opcode prefix that is simply delivered to the memory controller and/or to the flash memory die prior to/along with memory operation commands (“opcode”) for program, read, and/or erase, according to one embodiment. The embodiments of the present disclosure also enable the flash memory die to automatically exit the faster access operation mode after a single operation. The embodiments of the present disclosure enable the flash memory die to be reconfigured to its default operation mode with the use of an opcode prefix. Thus, embodiments of the present disclosure reduce the amount of time lost in both configuring and unconfiguring a memory controller and/or flash memory die for non-default access operation modes.

Embodiments of the present disclosure include a system for reconfiguring flash memory from a default access operation mode to a non-default access operation mode using opcode prefixes. Embodiments of the present disclosure alter the operation of memory controllers and/or the operation of flash memory die by enabling the flash memory die to enter a non-default (e.g., faster) access operation mode. The non-default access operation mode (e.g., SLC mode) is entered by providing a prefix instruction or opcode prefix to the memory controller and/or to the flash memory die prior to memory operation commands (“opcode”) for program, read, and/or erase, according to one embodiment. The flash memory die is configured to automatically exit the non-default access operation mode after a single operation, or the flash memory die is configured to exit the non-default access operation mode upon receipt of another opcode prefix, according to one embodiment.

A memory controller is provided, according to one embodiment. The memory controller includes opcode prefix logic to switch operation of a flash memory die (e.g., a LUN) between a default memory access operation mode and a non-default memory access operation mode, in response to opcode prefixes received with opcodes for memory access operations, according to one embodiment.

A system is provided, according to one embodiment. The system includes a memory array having a plurality of memory cells, wherein each of the plurality memory cells is to store one of at least four programming levels in a default memory access operation mode, according to one embodiment. The system includes a memory controller, according to one embodiment. The memory controller includes opcode prefix logic to switch operation of a flash memory die between a default memory access operation mode and a non-default memory access operation mode, in response to opcode prefixes received with opcodes for memory access operations, according to one embodiment.

A computer readable storage device is provided, according to one embodiment. The computer readable storage device stores instructions that when executed by one or more processors result in operations, according to one embodiment. The operations include receive an opcode for a memory access operation on a plurality of memory cells in a flash memory array; receive an opcode prefix with the opcode to perform the memory access operation on the plurality of memory cells in a non-default memory access operation mode; and perform the memory access operation on the plurality of memory cells in the non-default memory access operation mode, according to one embodiment.

A method is provided, according to one embodiment. The method includes receiving an opcode for a memory access operation on a plurality of memory cells in a flash memory array; receiving an opcode prefix with the opcode to perform the memory access operation on the plurality of memory cells in a non-default memory access operation mode; and performing the memory access operation on the plurality of memory cells in the non-default memory access operation mode, according to one embodiment.

As used herein the term logical unit number (“LUN”) denotes an identification number associated with a memory die and used to address a particular memory die from several memory die that are operated by (or share) one or more common memory controllers.

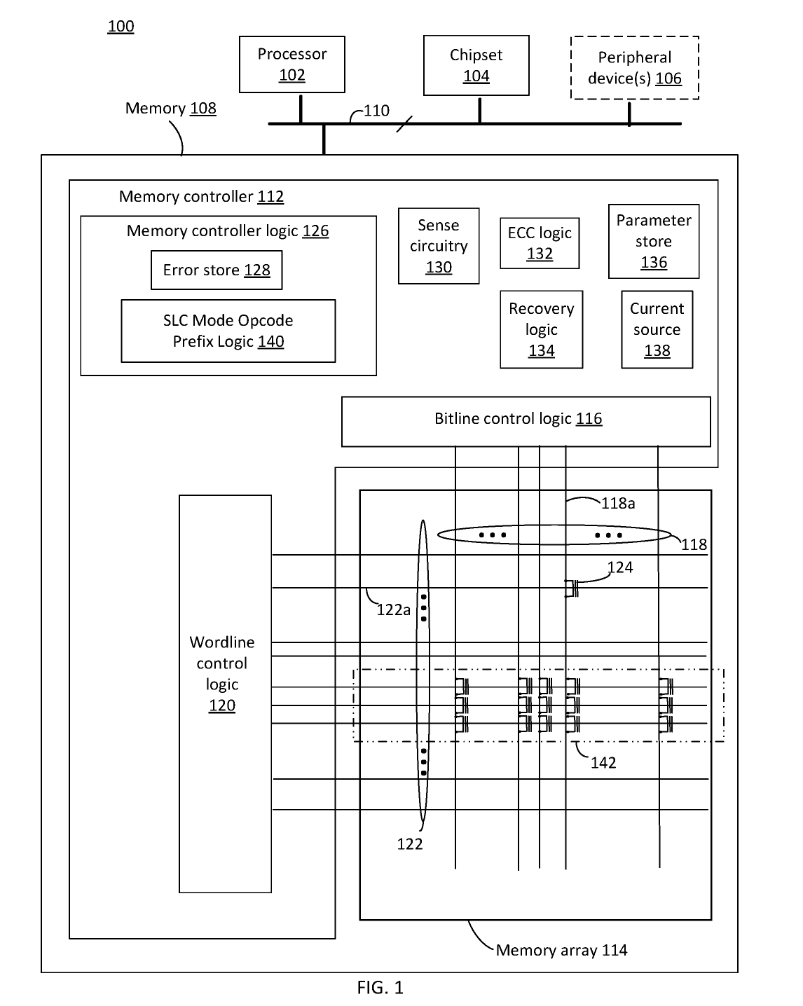

FIG. 1 depicts an illustrative system 100 that executes prefixes to memory access opcodes, to increase the speed (decrease the overhead) of single-level cell (“SLC”) configurations of memory cells in a memory array, according to one embodiment. System 100 may correspond to: a computing device that includes, but is not limited to, a server, a workstation computer, a desktop computer, a laptop computer, a tablet computer (e.g., iPad®, GalaxyTab® and the like), an ultraportable computer, an ultramobile computer, a netbook computer and/or a subnotebook computer; and/or a mobile telephone including, but not limited to a smart phone, (e.g., iPhone®, Android®-based phone, Blackberry®, Symbian®-based phone, Palm®-based phone, etc.) and/or a feature phone.

The system 100 may include a processor 102 that is communicatively coupled to a chipset 104, peripheral device(s) 106, and a memory 108, according to one embodiment. The processor 102, the chipset 104, the peripheral device(s) 106, and the memory 108 are communicatively and/or physically coupled to each other through one or more buses 110, according to one embodiment. The processor 102 may correspond to a single core or a multi-core general purpose processor, such as those provided by Intel® Corporation, etc., according to one embodiment. The chipset 104 may include, for example, a set of electronic components that includes the one or more buses 110 to facilitate communication between components of the system. The chipset 104 may manage data flow between the processor 102, the memory 108, and the peripheral device(s) 106. The peripheral device(s) 106 may include, for example, user interface device(s) including a display, a touch-screen display, a printer, a keypad, a keyboard, etc., wired and/or wireless communication logic, and storage device(s) including hard disk drives, solid-state drives, removable storage media, etc., according to one embodiment.

The memory 108 is coupled to the processor 102 and is configured to receive instructions, receive addresses, receive data, and provide data to the processor 102, in response to one or more instructions received from the processor 102, according to one embodiment. The memory 108 may be a package of one or more memory controllers and one or more memory dice, according to one embodiment. The memory 108 may be a solid-state drive (“SSD”) package that includes a number of flash packages configured as one or more memory arrays, according to one embodiment. The memory 108 is configured to provide requested data to the processor by performing page reads of a memory array of the memory 108, according to one embodiment. The memory 108 may be a non-volatile memory, e.g., a storage medium that does not require power to maintain the state of data stored by the storage medium, according to one embodiment. Non-volatile memory may include, but is not limited to, a NAND flash memory (e.g., Single-Level Cell (“SLC”), Multi-Level Cell (“MLC”), Tri-Level Cell (“TLC”), Quad-Level Cell (“QLC”), or some other NAND flash memory type), NOR memory, solid-state memory (e.g., planar or three-dimensional (“3D”) NAND flash memory or NOR flash memory), storage devices that use chalcogenide phase change material (e.g., chalcogenide glass), byte addressable non-volatile memory devices, ferroelectric memory, silicon-oxide-nitride-oxide-silicon (“SONOS”) memory, polymer memory (e.g., ferroelectric polymer memory), byte addressable random accessible 3D XPoint™ memory, ferroelectric transistor random access memory (“Fe-TRAM”), magnetoresistive random access memory (“MRAM”), phase change memory (“PCM”, “PRAM”), resistive memory, ferroelectric memory (“F-RAM”, “FeRAM”), spin-transfer torque memory (“STT”), thermal assisted switching memory (“TAS”), millipede memory, floating junction gate memory (“FJG RAM”), magnetic tunnel junction (“MTJ”) memory, electrochemical cells (“ECM”) memory, binary oxide filament cell memory, interfacial switching memory, battery-backed RAM, ovonic memory, nanowire memory, electrically erasable programmable read-only memory (“EEPROM)”, etc. In some embodiments, the byte addressable random accessible 3D XPoint™ memory may include a transistor-less stackable cross point architecture in which memory cells sit at the intersection of words lines and bitlines and are individually addressable and in which bit storage is based on a change in bulk resistance, in accordance with various embodiments.

The memory 108 includes a memory controller 112 that is configured to address, write to and read from, a memory array 114, according to one embodiment. The memory controller 112 is configured to perform memory access operations (e.g., reading a target memory cell and/or writing to a target memory cell), ECC check operations, and memory cell recovery operations, according to one embodiment. The memory array 114 includes a plurality of memory cells that are organized by one or more strings (e.g., columns), pages (e.g., wordlines or rows), blocks, planes, tiles, and/or dice of memory cells, according to one embodiment.

The memory controller 112 uses bitline control logic and wordline control logic to address and access the memory array 114, according to one embodiment. The memory controller 112 includes bitline control logic 116 that controls a plurality of bitlines 118 (individually, for example, bitline 118a), according to one embodiment. The bitline control logic 116 includes controller logic for inhibit voltages for portions or planes of the memory array 114, according to one embodiment. The memory controller 112 includes wordline control logic 120 that applies voltage levels to a plurality of wordlines 122 (individually, for example, wordline 122a), according to one embodiment. The wordline control logic 120 includes a voltage regulator that generates one or more threshold voltages to access memory cells (e.g., a memory cell 124) within the memory array 114, according to one embodiment.

The wordline control logic 120 is configured to receive target wordline address(es) from the memory controller 112 and to select or access one or more wordlines for reading (or writing operations), according to one embodiment. For example, the wordline control logic 120 may be configured to select a target wordline by coupling a wordline select bias voltage from a voltage regulator to the target wordline(s). The wordline control logic 120 may be configured to deselect one or more target wordlines by decoupling the target wordline(s) from the wordline select bias voltage and/or by coupling a wordline deselect bias voltage to the wordline, according to one embodiment. The wordline control logic 120 includes global wordline drivers, according to one embodiment. The wordline control logic 120 includes select gate source (“SGS”) and select gate drain (“SGD”) drivers, according to one embodiment. The voltage regulator associated with the wordline control logic 120 is a wordline (“WL”) regulator, according to one embodiment.

The memory controller 112 may include additional logic to facilitate memory array operations and communication with one or more of the processor 102, the chipset 104, or the peripheral device(s) 106, according to one embodiment. The memory controller 112 may include one or more of memory controller logic 126, an error store 128, sense circuitry 130, ECC logic 132, recovery logic 134, a parameter store 136, and/or a current source 138, according to one embodiment. The memory controller logic 126 may configured to perform operations associated with memory controller 112. For example, the memory controller logic 126 may manage communications with the processor 102 and may be configured to identify one or more target wordlines associated with each received memory address (e.g., in a read request). The error store 128 includes the fail type for memory cells read or access fails, according to one embodiment. The sense circuitry 130 may be configured to detect a quantity of current passing through a memory cell, e.g., during a read operation, according to one embodiment. The ECC logic 132 is configured to provide error checking functionality for memory controller 112, according to one embodiment. The recovery logic 134 is configured to manage recovery of fail opens and/or set fails for associated memory cells identified by ECC logic 132 and/or memory controller logic 126, according to one embodiment. The parameter store 136 is configured to store the number of adjacent memory cells to select and parameters associated with a sequence of recovery pulses, to facilitate error correction. The number of adjacent memory cells to select may be based, at least in part, on fail type, memory array density, and/or maximum current available from the current source 138, according to one embodiment. The current source 138 supplies current to one or more portions of the memory 108, according to one embodiment.

The memory controller logic 126 includes SLC mode opcode prefix logic 140 to enable the memory controller 112 to interpret prefixes to opcodes that change the configuration of memory cells from a default mode (e.g., MLC, TLC, QLC) to SLC, according to one embodiment. Despite the advantages of using SLC mode in a memory array (e.g., faster read/write times), traditional techniques for entering SLC mode in a memory array include transmitting a series of commands to enter SLC mode and to exit SLC mode, with the commands adding up to 10% reductions in speeds for SLC operations. For example, for some flash memory cells having 30 μs SLC read access times, and the time consumed to configure the memory cell or the memory controller to enter SLC mode can be as much as 3 μs. These high overhead costs cause a useful feature (e.g., caching with SLC mode) of flash memory arrays less attractive.

The SLC mode opcode prefix logic 140 enables the memory controller 112 to resolve the long-standing need to address the overhead times associated within entering and exiting SLC mode. The SLC mode opcode prefix logic 140 enables low-overhead communications between the processor 102, the memory controller 112 and the wordline control logic 120 for entering and exiting SLC mode during memory cell operations.

Although the SLC mode opcode prefix logic 140 is described herein as enabling default mode to SLC mode configurations with an opcode prefix, it is to be understood that an opcode prefix could be used to enable QLC to TLC mode configurations, QLC to MLC mode configurations, or TLC to MLC mode configurations, in addition to default mode to SLC mode memory configurations, according to various embodiments.

In some implementations, a group of pages 142 in the memory array 114 are allocated for being configurable into SLC mode from a default QLC, TLC, or MLC. The group of pages 142 may be a block of memory cells, a tile of memory cells, a plane of memory cells, or one of a number of flash memory dice (e.g., referenced by its LUN), according to various embodiments. That is, the memory array 114 may represent a logical combination of memory cell arrays from a number of flash memory dice.

The memory array 114 may be physically and logically organized into two or more planes of memory cells, according to one embodiment. The planes enable concurrent and/or identical operations on the memory array 114, according to one embodiment. Each of the planes include a number of memory blocks (not shown), and each of the memory blocks include a number of pages of memory cells, according to one embodiment. A memory block is the smallest unit of memory cells that can be erased, according to one embodiment. A page of memory cells is the smallest unity of memory cells that can be programmed, according to one embodiment.

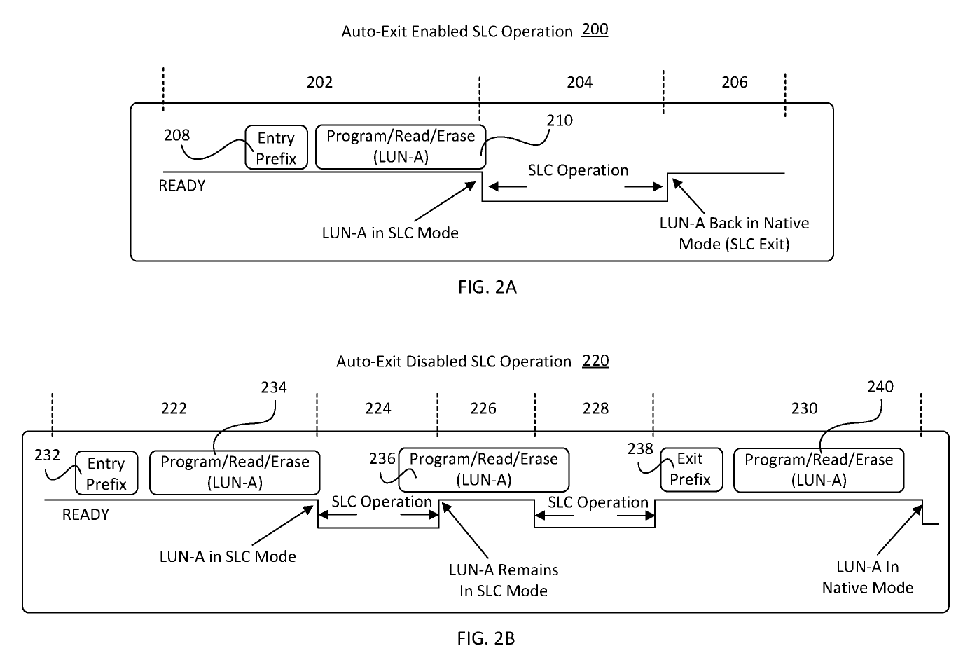

FIGS. 2A and 2B are illustrative simplified diagrams of operations for entering and exiting non-default access operation modes in flash memory, according to one embodiment.

FIG. 2A illustrates an auto-exit enabled SLC operation 200 that uses an opcode prefix to configure flash memory into a non-default access operation mode, and that causes the flash memory to automatically exit the non-default access operation mode after performing a single memory access operation. The operation 200 includes a first operation 202, a second operation 204, and a third operation 206 for configuring flash memory into and out of a non-default access operation mode, according to one embodiment.

In the first operation 202, a flash memory die receives an entry prefix 208 and an opcode 210, according to one embodiment. The entry prefix 208 is a first opcode, and the opcode 210 is a second opcode, according to one embodiment. The entry prefix 208 along with memory access operation 210, causes the flash memory die to switch to non-default access operation mode where it adjusts the program voltage and read verify voltage to the non-default mode, for example to SLC levels. The entry prefix 208 causes the flash memory die to adjust read voltage levels and program voltage levels that are delivered to wordlines in a memory array, so that the read voltage levels and the program voltage levels read and program memory cells in the memory array at, for example, SLC levels instead of MLC, TLC, or QLC levels, according to one embodiment.

The flash memory die receives the entry prefix 208 and the opcode 210 from a memory controller, which receives the entry prefix 208 and the opcode 210 from one or more processors, according to one embodiment. In one embodiment, the memory controller updates one or more data structures or registers to keep track of which memory cells and/or which flash memory dice are configured in a non-default access operation mode.

The opcode 210 includes a command (e.g., read, write, or erase) and one or more addresses, according to one embodiment. The one or more addresses include addresses within a flash memory die (e.g., page, block, tile, and/or plane addresses) and addresses for a flash memory die (e.g., the logical unit number (“LUN”)), according to one embodiment. An address for a flash memory die, such as the LUN, enable a memory controller to distinguish/access a particular one from a number of flash memory dice, when a configuration includes several flash memory dice, according to one embodiment.

In the second operation 204 the flash memory die performs the operation of the opcode 210 in the non-default access operation mode (e.g., SLC mode) and automatically exits the non-default access operation mode to return to the default access operation mode (e.g., MLC, TLC, or QLC mode), according to one embodiment. In the non-default access operation mode, the flash memory die masks off feature sets and capabilities of the default or native access operation mode so that operations related to, for example, TLC mode are inaccessible, according to one embodiment.

In the third operation 206, the flash memory die awaits additional commands in the default access operation mode, according to one embodiment.

FIG. 2B illustrates an auto-exit disabled SLC operation 220 that uses an opcode prefix to configure flash memory into a non-default access operation mode, and that causes the flash memory to remain in the non-default access operation mode until another opcode prefix is received for returning to the default access operation mode, according to one embodiment. The operation 220 includes a first operation 222, a second operation 224, a third operation 226, a fourth operation 228, and a fifth operation 230, for configuring flash memory into and out of a non-default access operation mode, according to one embodiment.

In the first operation 222, a flash memory die receives an entry prefix 232 and an opcode 234, according to one embodiment. The entry prefix 232 is a first opcode, and the opcode 234 is a second opcode, according to one embodiment. The entry prefix 232 along with memory access operation 234, causes the flash memory die to switch to non-default mode where it adjusts the program voltage and read verify voltage to the non-default access operation mode. The entry prefix 232 causes the flash memory die to adjust read voltage levels and program voltage levels that are delivered to wordlines in a memory array, so that the read voltage levels and the program voltage levels read and program memory cells in the memory array at, for example, SLC levels instead of MLC, TLC, or QLC levels, according to one embodiment.

The flash memory die receives the entry prefix 232 and the opcode 234 from a memory controller, which receives the entry prefix 232 and the opcode 234 from one or more processors, according to one embodiment.

The opcode 234 includes a command (e.g., read, write, or erase) for an access operation and includes one or more addresses, according to one embodiment. The one or more addresses include addresses within a flash memory die (e.g., page, block, tile, and/or plane addresses) and addresses for a flash memory die (e.g., a LUN), according to one embodiment.

In the second operation 224 the flash memory die performs the access operation of the opcode 234 in the non-default access operation mode (e.g., SLC mode) and remains in the non-default access operation mode upon completion of the access operation, according to one embodiment.

In the third operation 206, the flash memory die receives (e.g., from a memory controller) an opcode 236, according to one embodiment.

In the fourth operation 228, the flash memory die performs the access operation of the opcode 236, while in the non-default access operation mode, according to one embodiment.

In the fifth operation 230, the flash memory die receives an exit prefix 238 and an opcode 240, according to one embodiment. The exit prefix 238 causes the flash memory die and/or the memory controller to interpret, process, and execute the access operation of the opcode 240 in the default access operation mode for the flash memory die, according to one embodiment. The entry prefix 232 is a first opcode prefix, and the exit prefix 238 is a second opcode prefix, according to one embodiment.

A typical flash memory opcode includes a beginning byte (i.e., 8 bits) of data, an address, and an ending byte of data. To use a few specific illustrative examples, a read page opcode can include 00h, an address, and 30h; a read page multi-plane opcode can include 00h, an address, and 32h; a program page opcode can include 80h, an address, and 10h; and an erase block opcode can include 60h, an address, and D0h, as an example. According to one embodiment, the opcode prefixes (e.g., entry prefix 208, 232, exit prefix 238) may be a single byte of data. As illustrative examples, an entry prefix for auto-exit enabled SLC operation may be the byte 3Bh, an entry prefix for auto-exit disabled SLC operation may be the byte 3Bh, and an exit prefix for auto-exit disabled SLC operation may be the byte 3Ch. In one embodiment, the entry prefix configures the memory controller and/or the flash memory die to enable or disable auto-exit mode. In another embodiment, auto-exit mode is enabled or disabled using one or more other opcodes, separately from entering and exiting the non-default access operations mode.

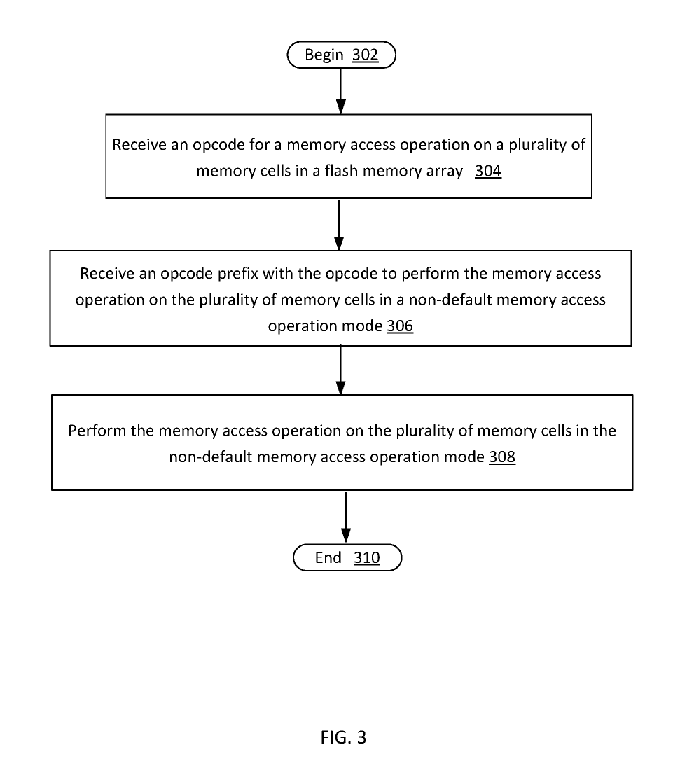

FIG. 3 is a high-level logic flow diagram of an illustrative method 300 for reconfiguring flash memory from a default access operation mode to a non-default access operation mode using opcode prefixes, in accordance with at least one embodiment described herein. The method 300 begins at 302.

At 304, the method 300 includes receiving an opcode for a memory access operation on a plurality of memory cells in a flash memory array, according to one embodiment.

At 306, the method 300 includes receiving an opcode prefix with the opcode to perform the memory access operation on the plurality of memory cells in a non-default memory access operation mode, according to one embodiment.

At 308, the method 300 includes performing the memory access operation on the plurality of memory cells in the non-default memory access operation mode, according to one embodiment.

The method 300 ends at 310.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment”, “an embodiment”, or “an implementation” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in any embodiment herein, the term “logic” may refer to an application, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, within the memory controller 112 that executes code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the memory controller circuitry or other systems may be combined in a system-on-a-chip (SoC) architecture.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800TM-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a memory controller, a method, and a system related to reducing program disturb degradation in a memory array, as discussed below.

### Example 1

According to this example there is provided a memory controller. The memory controller includes opcode prefix logic to switch operation of a flash memory die between a default memory access operation mode and a non-default memory access operation mode, in response to opcode prefixes received with opcodes for one or more memory access operations.

### Example 2

This example includes the elements of example 1, wherein the non-default memory access operation mode is single-level cell (“SLC”) mode, wherein the default memory access operation mode is one of multi-level cell (“MLC”) mode, tri-level cell (“TLC”) mode, or quad-level cell (“QLC”) mode.

### Example 3

This example includes the elements of example 1, wherein the non-default memory access operation mode is one of SLC mode or MLC mode, wherein the default memory access operation mode is one of TLC mode or QLC mode.

### Example 4

This example includes the elements of example 1, and further includes: wordline control logic to generate one or more first voltage levels to perform the one or more memory access operations on memory cells of a memory array in the default memory access operation mode, and to generate one or more second voltage levels to perform the one or more memory access operations on the memory cells of the memory array in a non-default memory access operation mode.

### Example 5

This example includes the elements of example 4, wherein the one or more first voltage levels include one or more first threshold voltage levels and one or more first programming voltage levels, wherein the one or more second voltage levels include one or more second threshold voltage levels and one or more second programming voltage levels.

### Example 6

This example includes the elements of example 1, wherein the one or more memory access operations include read, write, and erase.

### Example 7

This example includes the elements of example 1, wherein the opcode prefixes include an entry prefix to configure the flash memory die in the non-default memory access operation mode, wherein the flash memory die to automatically exit the non-default memory access operation mode to return to the default memory access operation mode after execution of a single one of the one or more memory access operations.

### Example 8

This example includes the elements of example 1, wherein the opcode prefixes include an entry prefix to configure the flash memory die in the non-default memory access operation mode, wherein the entry prefix also configures the flash memory die to automatically exit the non-default memory access operation mode to return to the default memory access operation mode after execution of a single one of the one or more memory access operations.

### Example 9

This example includes the elements of example 1, wherein an auto-exit opcode configures the flash memory die to enable or disable an auto-exit mode.

### Example 10

This example includes the elements of example 1, wherein the memory controller to receive the opcode prefixes and the opcodes, the memory controller to provide the opcode prefixes and the opcodes to one or more flash memory dice to configure the one or more flash memory dice in the non-default memory access operation mode.

### Example 11

This example includes the elements of example 1, wherein the opcode prefixes include an entry prefix and an exit prefix, the entry prefix to configure a flash memory die in the non-default memory access operation mode, the exit prefix to configure the flash memory die in the default memory access operation mode from the non-default memory access operation mode.

### Example 12

According to this example, there is provided a system. The system includes a memory array having a plurality of memory cells, wherein each of the plurality memory cells is to store one of at least four programming levels in a default memory access operation mode; and a memory controller The memory controller includes opcode prefix logic to switch operation of a flash memory die between a default memory access operation mode and a non-default memory access operation mode, in response to opcode prefixes received with opcodes for one or more memory access operations.

### Example 13

This example includes the elements of example 12, wherein the non-default memory access operation mode is single-level cell (“SLC”) mode, wherein the default memory access operation mode is one of multi-level cell (“MLC”) mode, tri-level cell (“TLC”) mode, or quad-level cell (“QLC”) mode.

### Example 14

This example includes the elements of example 12, wherein the memory controller further includes: wordline control logic to generate one or more first voltage levels to perform the one or more memory access operations on memory cells of a memory array in the default memory access operation mode, and to generate one or more second voltage levels to perform the operations on the memory cells of the memory array in a non-default memory access operation mode.

### Example 15

This example includes the elements of example 14, wherein the one or more first voltage levels include one or more first threshold voltage levels and one or more first programming voltage levels, wherein the one or more second voltage levels include one or more second threshold voltage levels and one or more second programming voltage levels.

### Example 16

This example includes the elements of example 12, wherein the one or more memory access operations include read, write, and erase.

### Example 17

This example includes the elements of example 12, wherein the opcode prefixes include an entry prefix to configure the flash memory die in the non-default memory access operation mode, wherein the flash memory die to automatically exit the non-default memory access operation mode to return to the default memory access operation mode after execution of a single one of the one or more memory access operations.

### Example 18

This example includes the elements of example 12, wherein the memory controller to receive the opcode prefixes and the opcodes, the memory controller to provide the opcode prefixes and the opcodes to one or more flash memory dice to configure the one or more flash memory dice in the non-default memory access operation mode.

### Example 19

This example includes the elements of example 12, wherein the opcode prefixes include an entry prefix and an exit prefix, the entry prefix to configure a flash memory die in the non-default memory access operation mode, the exit prefix to configure the flash memory die in the default memory access operation mode from the non-default memory access operation mode.

### Example 20

According to this example, there is provided a computer readable storage device having stored thereon instructions that when executed by one or more processors result in operations. The operations include receive an opcode for a memory access operation on a plurality of memory cells in a flash memory array; receive an opcode prefix with the opcode to perform the memory access operation on the plurality of memory cells in a non-default memory access operation mode; and perform the memory access operation on the plurality of memory cells in the non-default memory access operation mode.

### Example 21

This example includes the elements of example 20, wherein the memory access operation is a read, a write, or an erase operation.

### Example 22

This example includes the elements of example 20, wherein the operations include: automatically exit the non-default memory access operation mode; and perform subsequent memory access operations on the flash memory array in a default memory access operation mode after performance of the memory access operation.

### Example 23

This example includes the elements of example 20, wherein the opcode prefix is a first opcode prefix, wherein the opcode to perform the memory access operation is a first opcode to perform a first memory access operation, wherein the operations include: perform subsequent memory access operations on the flash memory array in the non-default memory access operation mode; receive a second opcode prefix with a second opcode to perform a second memory access operation in the default memory access operation mode; exit the non-default memory access operation mode after receipt of the second opcode prefix with the second opcode; and perform the second memory access operation in the default memory access mode.

### Example 24

This example includes the elements of example 20, wherein the non-default memory access operation mode is SLC mode.

### Example 25

According to this example, there is provided a method. The method includes receiving an opcode for a memory access operation on a plurality of memory cells in a flash memory array; receiving an opcode prefix with the opcode to perform the memory access operation on the plurality of memory cells in a non-default memory access operation mode; and performing the memory access operation on the plurality of memory cells in the non-default memory access operation mode.

### Example 26

This example includes the elements of example 25, wherein the memory access operation is a read, a write, or an erase operation.

### Example 27

This example includes the elements of example 25, further including: automatically exit the non-default memory access operation mode; and perform subsequent memory access operations on the flash memory array in a default memory access operation mode after performance of the memory access operation.

### Example 28

This example includes the elements of example 25, wherein the opcode prefix is a first opcode prefix, wherein the opcode to perform the memory access operation is a first opcode to perform a first memory access operation, wherein the method further includes: performing subsequent memory access operations on the flash memory array in the non-default memory access operation mode; receiving a second opcode prefix with a second opcode to perform a second memory access operation in the default memory access operation mode; exiting the non-default memory access operation mode after receiving the second opcode prefix with the second opcode; and performing the second memory access operation in the default memory access mode.

### Example 29

This example includes the elements of example 25, wherein the non-default memory access operation mode is SLC mode.

### Example 30

According to this example, there is provided a memory controller. The memory controller includes means for receiving an opcode for a memory access operation on a plurality of memory cells in a flash memory array; means for receiving an opcode prefix with the opcode to perform the memory access operation on the plurality of memory cells in a non-default memory access operation mode; and means for performing the memory access operation on the plurality of memory cells in the non-default memory access operation mode.

### Example 31

This example includes the elements of example 30, wherein the memory access operation is a read, a write, or an erase operation.

### Example 32

This example includes the elements of example 30, further including: means for automatically exiting the non-default memory access operation mode; and means for performing subsequent memory access operations on the flash memory array in a default memory access operation mode after performance of the memory access operation.

### Example 33

This example includes the elements of example 30, wherein the opcode prefix is a first opcode prefix, wherein the opcode to perform the memory access operation is a first opcode to perform a first memory access operation, wherein the memory controller further includes: means for performing subsequent memory access operations on the flash memory array in the non-default memory access operation mode; means for receiving a second opcode prefix with a second opcode to perform a second memory access operation in the default memory access operation mode; means for exiting the non-default memory access operation mode after receiving the second opcode prefix with the second opcode; and means for performing the second memory access operation in the default memory access mode.

### Example 34

This example includes the elements of example 30, wherein the non-default memory access operation mode is SLC mode.

### Example 35

This example includes the elements of examples 12 to 19, and further includes processor circuitry.

### Example 36

According to this example, there is provided a device comprising means to perform the method of any one of examples 25 to 29.

### Example 37

According to this example, there is provided a computer readable storage device having stored thereon instructions that when executed by one or more processors result in operations comprising: the method according to any one of examples 25 to 29.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A memory controller, comprising:
opcode prefix logic to switch operation of a flash memory die between a default memory access operation mode and a non-default memory access operation mode, in response to opcode prefixes received with opcodes for one or more memory access operations.

2. The memory controller of claim 1, wherein the non-default memory access operation mode is single-level cell (“SLC”) mode, wherein the default memory access operation mode is one of multi-level cell (“MLC”) mode, tri-level cell (“TLC”) mode, or quad-level cell (“QLC”) mode.

3. The memory controller of claim 1, further comprising:
wordline control logic to generate one or more first voltage levels to perform the one or more memory access operations on memory cells of a memory array in the default memory access operation mode, and to generate one or more second voltage levels to perform the one or more memory access operations on the memory cells of the memory array in a non-default memory access operation mode, wherein the one or more memory access operations include read, write, and erase.

4. The memory controller of claim 3, wherein the one or more first voltage levels include one or more first threshold voltage levels and one or more first programming voltage levels, wherein the one or more second voltage levels include one or more second threshold voltage levels and one or more second programming voltage levels.

5. The memory controller of claim 1, wherein the opcode prefixes include an entry prefix to configure the flash memory die in the non-default memory access operation mode, wherein the flash memory die to automatically exit the non-default memory access operation mode to return to the default memory access operation mode after execution of a single one of the one or more memory access operations.

6. The memory controller of claim 1, wherein the memory controller to receive the opcode prefixes and the opcodes, the memory controller to provide the opcode prefixes and the opcodes to one or more flash memory dice to configure the one or more flash memory dice in the non-default memory access operation mode.

7. The memory controller of claim 1, wherein the opcode prefixes include an entry prefix and an exit prefix, the entry prefix to configure a flash memory die in the non-default memory access operation mode, the exit prefix to configure the flash memory die in the default memory access operation mode from the non-default memory access operation mode.

8. A system, comprising:
a memory array having a plurality of memory cells, wherein each of the plurality memory cells is to store one of at least four programming levels in a default memory access operation mode; and
a memory controller, including:
opcode prefix logic to switch operation of a flash memory die between a default memory access operation mode and a non-default memory access operation mode, in response to opcode prefixes received with opcodes for one or more memory access operations.

9. The system of claim 8, wherein the non-default memory access operation mode is single-level cell (“SLC”) mode, wherein the default memory access operation mode is one of multi-level cell (“MLC”) mode, tri-level cell (“TLC”) mode, or quad-level cell (“QLC”) mode.

10. The system of claim 8, wherein the memory controller further comprises:
wordline control logic to generate one or more first voltage levels to perform the one or more memory access operations on memory cells of a memory array in the default memory access operation mode, and to generate one or more second voltage levels to perform the operations on the memory cells of the memory array in a non-default memory access operation mode, wherein the one or more memory access operations include read, write, and erase.

11. The system of claim 10, wherein the one or more first voltage levels include one or more first threshold voltage levels and one or more first programming voltage levels, wherein the one or more second voltage levels include one or more second threshold voltage levels and one or more second programming voltage levels.

12. The system of claim 8, wherein the opcode prefixes include an entry prefix to configure the flash memory die in the non-default memory access operation mode, wherein the flash memory die to automatically exit the non-default memory access operation mode to return to the default memory access operation mode after execution of a single one of the one or more memory access operations.

13. The system of claim 8, wherein the memory controller to receive the opcode prefixes and the opcodes, the memory controller to provide the opcode prefixes and the opcodes to one or more flash memory dice to configure the one or more flash memory dice in the non-default memory access operation mode.

14. The system of claim 8, wherein the opcode prefixes include an entry prefix and an exit prefix, the entry prefix to configure a flash memory die in the non-default memory access operation mode, the exit prefix to configure the flash memory die in the default memory access operation mode from the non-default memory access operation mode.

15. A computer readable storage device having stored thereon instructions that when executed by one or more processors result in operations, comprising:
receive an opcode for a memory access operation on a plurality of memory cells in a flash memory array;
receive an opcode prefix with the opcode to perform the memory access operation on the plurality of memory cells in a non-default memory access operation mode; and
perform the memory access operation on the plurality of memory cells in the non-default memory access operation mode.

16. The computer readable storage device of claim 15, wherein the memory access operation is a read, a write, or an erase operation.

17. The computer readable storage device of claim 15, wherein the operations include:
automatically exit the non-default memory access operation mode; and
perform subsequent memory access operations on the flash memory array in a default memory access operation mode after performance of the memory access operation.

18. The computer readable storage device of claim 15, wherein the opcode prefix is a first opcode prefix, wherein the opcode to perform the memory access operation is a first opcode to perform a first memory access operation, wherein the operations include:
perform subsequent memory access operations on the flash memory array in the non-default memory access operation mode;
receive a second opcode prefix with a second opcode to perform a second memory access operation in the default memory access operation mode;
exit the non-default memory access operation mode after receipt of the second opcode prefix with the second opcode; and
perform the second memory access operation in the default memory access mode.

19. The computer readable storage device of claim 15, wherein the non-default memory access operation mode is SLC mode.

20. A method, comprising:
receiving an opcode for a memory access operation on a plurality of memory cells in a flash memory array;
receiving an opcode prefix with the opcode to perform the memory access operation on the plurality of memory cells in a non-default memory access operation mode; and
performing the memory access operation on the plurality of memory cells in the non-default memory access operation mode.

21. The method of claim 20, wherein the memory access operation is a read, a write, or an erase operation.

22. The method of claim 20, further including:
automatically exit the non-default memory access operation mode; and
perform subsequent memory access operations on the flash memory array in a default memory access operation mode after performance of the memory access operation.

23. The method of claim 20, wherein the opcode prefix is a first opcode prefix, wherein the opcode to perform the memory access operation is a first opcode to perform a first memory access operation, wherein the method further includes:
performing subsequent memory access operations on the flash memory array in the non-default memory access operation mode;
receiving a second opcode prefix with a second opcode to perform a second memory access operation in the default memory access operation mode;
exiting the non-default memory access operation mode after receiving the second opcode prefix with the second opcode; and
performing the second memory access operation in the default memory access mode.

24. The method of claim 20, wherein the non-default memory access operation mode is SLC mode.
